(19) United States
(12) Patent Application Publication
(10) Pub. No.: US 2019/0379247 A1
(43) Pub. Date: Dec. 12, 2019

(54) PERMANENT MAGNET

(71) Applicants: AISIN AW CO., LTD., Anjo-shi, Aichi-ken (JP); AISIN SEIKI KABUSHIKI KAISHA, Kariya-shi, Aichi-ken (JP)

(72) Inventors: Masayuki IKEMOTO, Anjo (JP); Tsuyoshi MIYAJI, Anjo (JP); Teppei TSUDA, Nagoya (JP)

(73) Assignees: AISIN AW CO., LTD., Anjo-shi, Aichi-ken (JP); AISIN SEIKI KABUSHIKI KAISHA, Kariya-shi, Aichi-ken (JP)

(21) Appl. No.: 16/341,586

(22) PCT Filed: Nov. 30, 2017
(86) PCT No.: PCT/JP2017/042996

§ 371 Date: Apr. 12, 2019

(30) Foreign Application Priority Data
Nov. 30, 2016 (JP) 2016-233186

(51) Int. Cl. H02K 1/27; H02K 41/03; H02K 1/02; H02K 15/03; H02K 1/24

(52) U.S. Cl. CPC H02K 1/276; H02K 41/033; H02K 2201/03; H02K 15/03; H02K 1/24; H02K 1/02

(57) ABSTRACT

A rotary electric machine that includes a rotor; and a permanent magnet, wherein: in an axially orthogonal section orthogonal to a rotational axis of the rotor in an attached state in which the permanent magnet is attached to the rotor, the permanent magnet has an uneven shape, in which both of two magnetic pole surfaces are repeatedly projected and recessed with a curvature that is larger than an average curvature of magnetic pole surfaces.

### BACKGROUND

The present disclosure relates to a permanent magnet for a rotor of a rotary electric machine.

There is a rotor of a permanent magnet type rotary electric machine, that is formed with permanent magnets embedded in a rotor core. Examples of such a rotor are described in the following JP 2013-207977 A and JP 2016-82696 A. Hereinafter, symbols indicated with brackets in the description of the background art are the symbols that are used in the referenced documents. A rotor (11) illustrated in JP 2013-207977 A is formed with flat plate-shaped permanent magnets (102) embedded in a rotor core (101) (see JP 2013-207977 A: FIGS. 2 to 4). The rotor (11) of JP 2013-207977 A has four magnetic poles (two pairs of poles). JP 2016-82696 A also illustrates a rotor that is formed with flat plate-shaped permanent magnets (21) embedded in a rotor core (20). The rotor has eight magnetic poles (four pairs of poles).

Hereinafter, a description will be given with reference to FIG. 10 which illustrates an example of a rotor 200 similar to that of JP 2013-207977 A. When considering the processing cost of permanent magnets, it is preferable that permanent magnets with a flat plate shape be used, as in JP 2013-207977 A and JP 2016-82696 A. However, a width in which the permanent magnets can be disposed (installation allowance width W illustrated in FIG. 10) is restricted by a radius of a rotor core 3 (radius r illustrated in FIG. 10) or the number of magnetic poles P. For example, suppose the radius r of the rotor core (101) of JP 2013-207977 A and the rotor core (20) of JP 2016-82696 A are the same. In such a case, it is possible to secure a wider installation allowance width W when there are four magnetic poles P as described in JP 2013-207977 A, compared to when there are eight magnetic poles P as described in JP 2016-82696 A. Here, flat plate-shaped permanent magnets 100 need to be elongated in a direction along a rotational axis X (axial direction), in order to increase magnetic flux of the flat plate-shaped permanent magnets 100 that have a width within the fixed installation allowance width W while maintaining the number of the magnetic poles P. However, if the flat plate-shaped permanent magnets 100 are elongated in the axial direction, the rotor 200 increases in size, which hinders downsizing of the rotary electric machine.

### SUMMARY

An exemplary aspect of the disclosure suppresses an increase in size of a rotor and that increases an effective magnetic flux of permanent magnets attached to the rotor.

In view of the above, recesses and projections are formed in a permanent magnet used for a rotor of a rotary electric machine, in an axially orthogonal section orthogonal to a rotational axis of the rotor in an attached state in which the permanent magnet is attached to the rotor. In the recesses and projections, both two magnetic pole surfaces are repeatedly projected and recessed with a curvature that is larger than an average curvature of the magnetic pole surfaces. From another point of view, the permanent magnet used for the rotor of the rotary electric machine has the uneven shape, in which a virtual central line is repeatedly protruded and recessed with the curvature that is larger than the average curvature of the magnetic pole surfaces. Here, the virtual central line connects intermediate positions of a separation distance of the two magnetic pole surfaces, in the axially orthogonal section orthogonal to the rotational axis of the rotor in the attached state in which the permanent magnet is attached to the rotor.

Between a straight line and a curved line that connect two same points, the curved line is longer. Here, in the axially orthogonal section, a comparison will be made between a rectangular flat plate-shaped permanent magnet, in which the magnetic pole surface is linear, and the curved permanent magnet, in which the magnetic pole surface has the recesses and projections and which has the uneven shape. In the axially orthogonal section in the attached state, even if a length between end portions of the permanent magnet in a circumferential direction are the same, an extending length of the magnetic pole surface is longer for the permanent magnet, in which the magnetic pole surface has a curved section, than the rectangular flat plate-shaped permanent magnet, in which the magnetic pole surface has a linear section. More effective magnetic flux is generated if a surface area of the magnetic pole surface is larger. Thus, it is possible to increase the effective magnetic flux without increasing the length of the permanent magnet in the circumferential direction of the rotor core, by making the section of the magnetic pole surface curved. That is, with the present configuration, it is possible to suppress an increase in the size of the rotor as well as increase the effective magnetic flux of the permanent magnet attached to the rotor.

Further features and advantages of the permanent magnet used for the rotor of the rotary electric machine will be apparent from the following description of embodiments which is given with reference to the accompanying drawings.

### BRIEF DESCRIPTION OF THE DRAWINGS

FIG. 1 is an explanatory view of a principle of increasing a surface area of a permanent magnet.

FIG. 2 is an axially orthogonal sectional view of an example of a rotor.

FIG. 3 is a sectional view of an example of the permanent magnet in an axially orthogonal section in an attached state.

FIG. 4 is a sectional view of an example of the permanent magnet in the axially orthogonal section in the attached state.

FIG. 5 is an axial partial sectional view of the rotor according to an example of magnetic flux generation direction of the permanent magnet.

FIG. 6 is an axial partial sectional view of the rotor according to an example of magnetic flux generation direction of the permanent magnet.

FIG. 7 is a sectional view of the permanent magnet according to an example of magnetic flux generation direction in the axially orthogonal section in the attached state.

FIG. 8 is a sectional view of an example of the permanent magnet in the axially orthogonal section in the attached state.

FIG. 9 is a sectional view of an example of the permanent magnet in the axially orthogonal section in the attached state.

FIG. 10 is an axially orthogonal section of an example of a typical rotor.

### DETAILED DESCRIPTION OF EMBODIMENTS

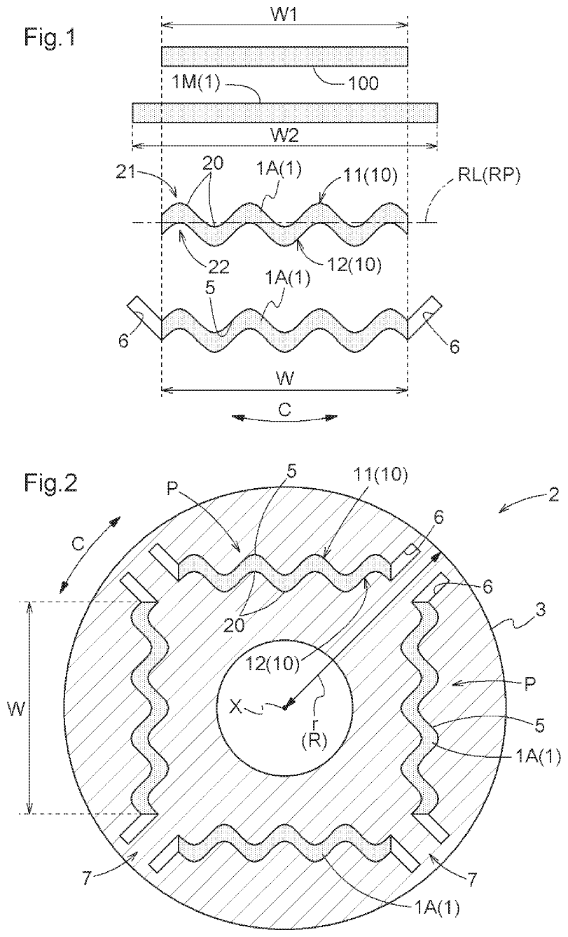

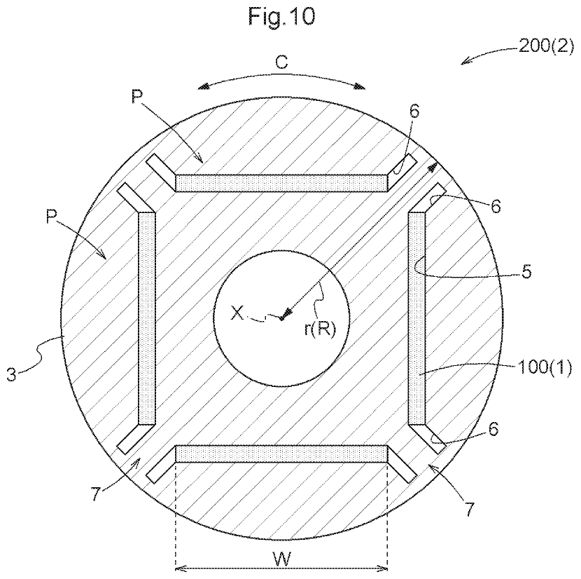

Embodiments of a rotor of an interior permanent magnet rotary electric machine will be described below with reference to the drawings. FIG. 1 is a sectional view of permanent magnets 1 in an attached state, in which the permanent magnets 1 are attached to a rotor 2. FIG. 2 is an axially orthogonal sectional view of an example of the rotor 2 with the permanent magnets 1 attached. FIG. 10 is an axially orthogonal section of an example of a typical rotor 200 as a comparative example. The rotor 2 and the rotor 200 that are illustrated in FIGS. 2 and 10 both have four poles (two pairs of poles).

In the rotor 200 of the comparative example illustrated in FIG. 10, flat plate-shaped permanent magnets (flat plate-shaped permanent magnets 100) are embedded in magnet insertion holes 5 that are formed in a rotor core 3. In the magnet insertion holes 5, air gaps indicated by the reference numeral 5 are formed other than spaces in which the flat plate-shaped permanent magnets 100 are inserted. The air gaps are called flux barriers 6 and are provided to suppress short circuiting of magnetic flux between magnetic poles P that are adjacent to each other in a circumferential direction C of the rotor 200 (magnetic flux short circuiting between magnetic poles). Between the flux barriers 6 of the adjacent magnetic poles P, there are paths (q axis magnetic flux paths 7) of magnetic flux (so-called q axis magnetic fluxes in a d-q axis vector coordinate system) for generating reluctance torque.

Thus, there is a limit to a width (installation allowance width W) in which each flat plate-shaped permanent magnet 100 is installed in one magnetic pole P along the circumferential direction C. FIG. 10 illustrates the example of the rotor 200 that has four magnetic poles P (two pairs of poles). In cases where the rotor 200 has even more magnetic poles P (such as eight poles (four pairs of poles)), the installation allowance width W will be even shorter. The longer a radius of the rotor core 3 (radius r, for example) becomes, the longer a length in the circumferential direction C becomes. Thus, if the number of magnetic poles P is the same, it is possible to increase the length of the installation allowance width W if the length of the radius r is increased. That is, the installation allowance width W is dependent on the number of magnetic poles P (number of pole pairs) and the radius of the rotor core 3 (radius r).

The number of magnetic poles P is determined by requirement specifications of the rotary electric machine including reduction of cogging torque. Thus, if the installation allowance width W of the permanent magnets 1 are widened while the number of poles is maintained, the radius (radius r) of the rotor core 3 needs to be increased. However, an increase in the radius r leads to the rotor 2 increasing in size and the rotary electric machine increasing in size, which is not favorable. In order to increase magnetic flux from the permanent magnets 1 while maintaining the radius r, there is a need to increase the length of the permanent magnets 1 in a direction of a rotational axis X (axial direction) of the rotor 2. However, even with this method, the rotor 2 increases in size in the axial direction and the rotary electric machine also increases in size.

In recent years, there has been an increase in the use of magnets using rare earth, as magnets with a strong magnetic force. An example of this is a neodymium magnet. Each neodymium magnet is typically formed by sintering a molding that uses a compound, in which a magnet material powder (pulverized magnetite etc. formed into powder) and a binder are mixed. Costs are incurred for a process of cutting the neodymium sintered magnet after sintering. Thus, in many cases, the flat plate-shaped permanent magnets 100 are embedded in the rotor core 3, as illustrated in FIG. 10, in the case where the rotor 2 uses neodymium sintered magnets. If magnetic flux generated by the neodymium sintered magnets is to be further increased, the rotor 2 may increase in size as described above.

It is known that magnetic flux generated by the permanent magnets 1 increase as surface areas of magnetic pole surfaces 10 increase. Thus, it is possible to increase magnetic flux while suppressing an increase in the size of the rotor 2, if the surface areas of the magnetic pole surfaces 10 of the permanent magnets 1 are increased while the installation allowance width W is maintained. The explanatory view of FIG. 1 shows the principle of increasing the surface area of the magnetic pole surfaces 10 in this way. The flat plate-shaped permanent magnet 100 illustrated at the top of FIG. 1 is the same as the flat plate-shaped permanent magnets 100 illustrated in FIG. 10. In the following description, a length of the permanent magnets 1 in a direction along the installation allowance width W, in the attached state in which the permanent magnets 1 are attached to the rotor core 3, is referred to as a “width of the permanent magnets”. FIGS. 1 and 10 illustrate a case where a width W1 of the flat plate-shaped permanent magnets 100 is a length that corresponds to the installation allowance width W (maximum allowable width of the flat plate-shaped permanent magnets 100).

Here, it is possible to increase magnetic flux that is generated, by changing the width W1 of the flat plate-shaped permanent magnets 100 to a width “W2” that is larger than the width “W1”, as with an enlarged permanent magnet 1M illustrated by the second drawing from the top in FIG. 1. However, since the installation allowance width W is equal to “W1”, as described above, it is not possible to use a permanent magnet 1M that has the width “W2”. As illustrated in the third drawing from the top in FIG. 1, the enlarged permanent magnet 1M is deformed so that the magnetic pole surfaces 10 of the enlarged permanent magnet 1M have recesses and projections 20. Thus, the permanent magnet 1 (1A) in which the width of the permanent magnet is within the installation allowance width W is formed. Specifically, after a magnetic field of a permanent magnet having the width W2 of the enlarged permanent magnet 1M and a flat plate shape is oriented, the permanent magnet is deformed and sintered using a forming mold so that the permanent magnet has the shape of the permanent magnet 1 (1A). Thus, the permanent magnet 1 (1A) is formed.

For example, first, a compound is produced by mixing a magnet material powder (pulverized magnetite etc. formed into a powder) and a binder. The compound is formed into a shape conforming to the flat plate-shaped enlarged permanent magnet 1M, for example. Then, the magnetic field is orientated by applying a magnetic field to the molding. The molding, in which the magnetic field orientation is finished, is deformed into a prescribed shape (in this case, the shape of the permanent magnet 1 (1A) having the recesses and projections 20). The molding is then solidified by being sintered, and thus, the permanent magnet 1 (1A) is formed.

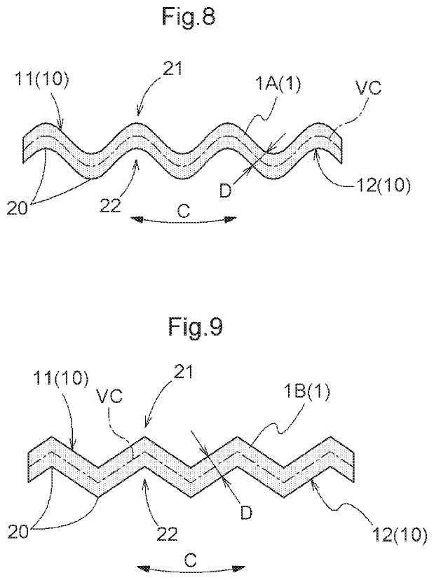

The formed permanent magnet 1 (1A) has an uneven shape in the axially orthogonal section orthogonal to the rotational axis X of the rotor 2 in the attached state in which the permanent magnet 1 (1A) is attached to the rotor 2. The permanent magnet 1 (1A) has the recesses and projections 20 in which both of the two magnetic pole surfaces 10 are repeatedly projected and recessed with a curvature that is larger than an average curvature of the magnetic pole surfaces 10. By forming the magnet insertion hole 5 in the rotor core 3 so that the permanent magnet 1 (1A) can be stored therewithin, it is possible to obtain the rotor 2 in which the amount of magnetic flux generated is increased while maintaining the installation allowance width W (see drawing at the bottom of FIG. 1 and FIG. 2). From another point of view, in the axially orthogonal section, the permanent magnet 1 (1A) has the uneven shape (20), in which a virtual central line VC is repeatedly projected and recessed with the curvature that is larger than the average curvature of the magnetic pole surfaces 10 (see FIG. 8). Here, the virtual central line VC connects intermediate positions of a separation distance D of the two magnetic pole surfaces 10.

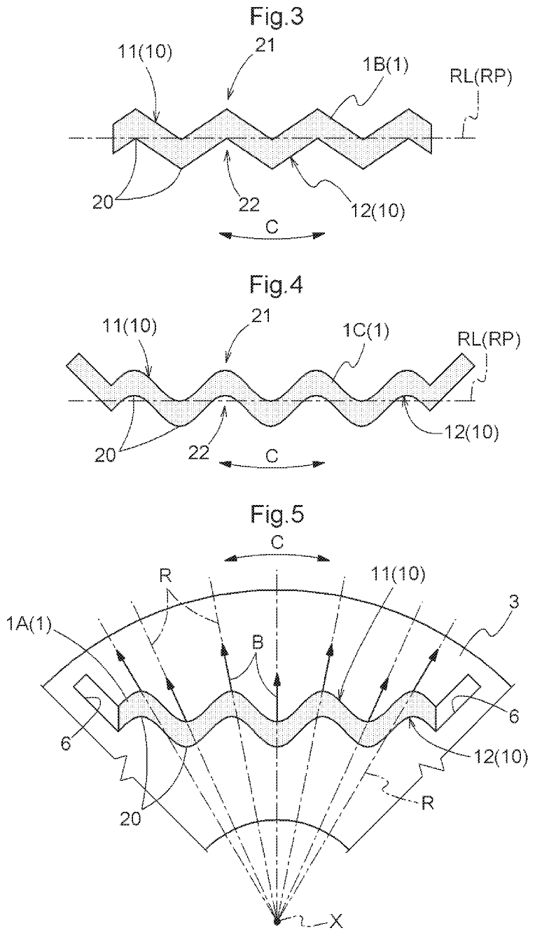

The recesses and projections 20 are not limited to a form that has an arc-shaped sectional shape. The sectional shape of the recesses and projections 20 may be triangular as in the case of the permanent magnet 1 (1B) illustrated in FIG. 3, or may be rectangular, although not shown. As illustrated in FIG. 3, even if the permanent magnet 1 (1B) is triangular, the permanent magnet 1 (1B) has an uneven shape, in the axially orthogonal section. The permanent magnet 1 (1B) has the recesses and projections 20 in which both of the two magnetic pole surfaces 10 are repeatedly projected and recessed with the curvature that is larger than the average curvature of the magnetic pole surfaces 10. As illustrated in FIG. 9, even if the permanent magnet 1 (1B) is triangular, in the axially orthogonal section, the permanent magnet 1 (1B) has the uneven shape (20), in which the virtual central line VC is repeatedly projected and recessed with the curvature that is larger than the average curvature of the magnetic pole surfaces 10. Here, the virtual central line VC connects intermediate positions of the separation distance D of the two magnetic pole surfaces 10.

Thus, even if the expression such as “the magnetic pole surfaces 10 have a “curved shape” in the axially orthogonal section” is used in the specification, the expression “curved shape” includes shapes that are not linear, that is, a “triangular shape and rectangular shape (or triangular wave shape and rectangular wave shape)” are included. The same also applies to the curvature. For example, even if the sectional shape is triangular or rectangular, it is possible to approximate the curvature to a set of a plurality of arcs by using a known Fourier series expansion. In this case, it is preferable that the curvature of the arc of a basic shape (which corresponds to a basic wave of the Fourier series expansion) among the arcs be the curvature of the recesses and projections 20.

In this way, it is possible to increase magnetic flux by increasing the surface area of the magnetic pole surfaces 10 of the permanent magnet 1. Thus, there is no need to increase the length of the rotor core 3 in the axial direction or increase the radius (radius r) of the rotor core 3. That is, since an increase in the size of the rotor 2 is suppressed, it is possible to suppress the cost of raw materials for coils that are wound around the rotor core 3 or a stator.

Similar to FIG. 10, FIG. 2 illustrates an example of a form in which each permanent magnet 1 is attached while there are air gaps that are the flux barriers 6 in the magnet insertion hole 5. However, the example does not prevent the form in which the permanent magnet 1 (1C) is embedded in the rotor core 3, including the spaces equivalent to the flux barriers 6, as is the case of the permanent magnet 1 (1C) illustrated in FIG. 4.

Both of the two magnetic pole surfaces 10 of each permanent magnet 1 (1A, 1B, 1C) illustrated in FIGS. 1 to 4 have recesses and projections 20 which are repeatedly projected and recessed with the curvature that is larger than the average curvature of the magnetic pole surfaces 10. The recesses and projections 20 in the attached state are continuously changed along the rotor 2 in the circumferential direction C. Thus, the permanent magnet 1 (1A, 1B, 1C) is able to regularly generate a stable magnetic flux.

Here, to distinguish the two magnetic pole surfaces 10, they are called a first magnetic pole surface 11 and a second magnetic pole surface 12. On the two magnetic pole surfaces 10 of the permanent magnet 1 (1A, 1B, 1C) illustrated in FIGS. 1 to 4, the recesses and projections 20 that are repeatedly projected and recessed are formed with the following rules. That is, a recessed portion 22 of the recesses and projections 20 of the first magnetic pole surface 11 and a projected portion 21 of the recesses and projections 20 of the second magnetic pole surface 12 are formed at corresponding positions along the circumferential direction C of the rotor 2 in the attached state. The projected portion 21 of the recesses and projections 20 of the first magnetic pole surface 11 and the recessed portion 22 of the recesses and projections 20 of the second magnetic pole surface 12 are formed at corresponding positions along the circumferential direction C of the rotor 2 in the attached state.

In this way, since the recessed portion 22 and the projected portion 21 correspond to each other between different magnetic pole surfaces, a thickness of the permanent magnet 1 in a direction orthogonal to an approximate flat plane RP of the magnetic pole surface 10 is substantially uniformized, as with the permanent magnet 1 (1A, 1B, 1C) illustrated in FIGS. 1 to 4. The approximate flat plane RP is a flat plane obtained by approximating the magnetic pole surfaces (10) that are curved in the axially orthogonal section to be linear in the axially orthogonal section. From another point of view, the separation distance D of the two magnetic pole surfaces 10 in the axially orthogonal section should be the same at each position in a direction along the magnetic pole surfaces 10 in the axially orthogonal section (see FIGS. 8, 9). If the thickness of the permanent magnet 1 can be uniformized, the permanent magnet 1 is not easily demagnetized, and thus, it is possible to stably generate magnetic flux.

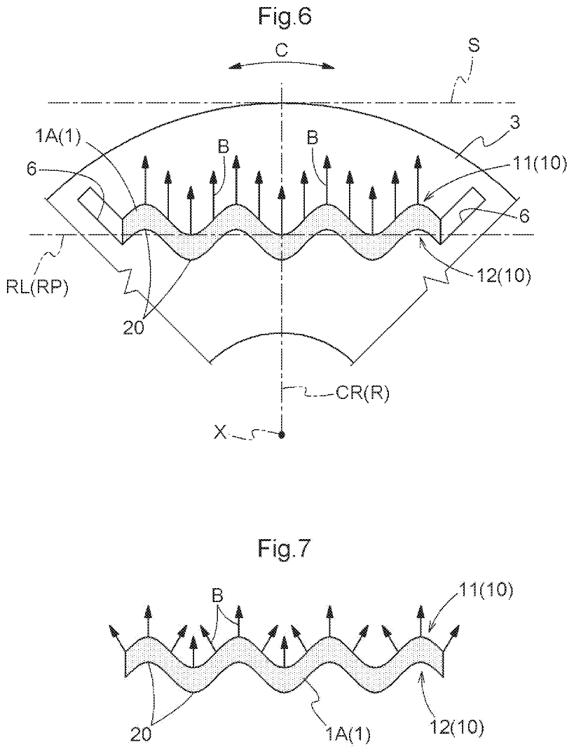

A direction of magnetic flux generated by the permanent magnet 1 can be variously set when the permanent magnet 1 is formed. For example, as illustrated in FIG. 5, in the permanent magnet 1 (1A) in the attached state, a direction of magnetic flux B at the magnetic pole surface 10 can be a direction orthogonal to a surface of the rotor 2. The example in FIG. 5 shows a form in which magnetic flux B from the magnetic pole surface 10 runs along a direction orthogonal to a tangent line to the surface of the rotor 2 (rotor core 3). FIG. 6 shows a form in which magnetic flux B from the magnetic pole surface 10 runs along a direction along (direction parallel to) a reference direction CR. Here, the reference direction CR is a direction orthogonal to a reference tangent line S to the surface of the rotor 2 (rotor core 3) at a center position of a magnetic pole P in the circumferential direction C in the axially orthogonal section.

In the forms in FIGS. 5 and 6, especially in the form in FIG. 6, there is less variation of magnetic flux B in the direction along an approximate straight line RL of the magnetic pole surface 10 in the axially orthogonal section. The approximate straight line RL is a straight line obtained by approximating the magnetic pole surfaces 10 that are curved in the axially orthogonal section to be linear in the axially orthogonal section. When magnetic flux B is generated from the permanent magnet 1 (1A) in this way, it is possible to form the rotor 2 that has magnetic characteristics close to that of a rotor of a surface permanent magnet rotary electric machine, by disposing the permanent magnet 1 close to the surface of the rotor core 3, for example. In the surface permanent magnet rotary electric machine, magnetic characteristics generally known as saliency or inverse saliency hardly appear and generation of torque known as ripple torque or cogging torque is suppressed more than an interior permanent magnet rotary electric machine. Thus, it is preferable that the permanent magnet 1 with the above magnetic characteristics be used in accordance with magnetic characteristics required by the rotary electric machine. As described above, when the molding of the compound is subject to orientation of the magnetic field, it is preferable that the magnetic field be oriented while taking into consideration the shape of the permanent magnet 1 (1A, 1B, 1C) obtained after sintering.

The direction of magnetic flux B generated by the permanent magnet 1 may be a direction orthogonal to the magnetic pole surface 10, as shown in FIG. 7. In this case, it is possible to uniformize the thickness of the permanent magnet 1 in the direction along magnetic flux B, for example. Thus, it is possible to suppress occurrence of demagnetization and form a very reliable permanent magnet 1.

In the above description, forms in which the permanent magnet 1 is configured of a neodymium sintered magnet were shown and described. However, the permanent magnet 1 is not limited to being formed of a neodymium sintered magnet and may be formed using a bonded magnet or a rubber magnet etc. Residual magnetic flux density of a bonded magnet and a rubber magnet after orientation of the magnetic field is low in comparison with a neodymium sintered magnet. Thus, it is preferable that the permanent magnet 1 be formed of a neodymium sintered magnet.

### [Summary of Embodiments]

The following provides a brief summary of the permanent magnet (1) described above.

In one aspect, in view of the above, the permanent magnet (1) used for the rotor (2) of the rotary electric machine has the uneven shape, in the axially orthogonal section orthogonal to the rotational axis (X) of the rotor (2), in the attached state in which the permanent magnet (1) is attached to the rotor (2). In the uneven shape, both of the two magnetic pole surfaces (10) are repeatedly projected and recessed with the curvature that is larger than the average curvature of the magnetic pole surfaces (10). From another point of view, the permanent magnet (1) used for the rotor (2) of the rotary electric machine has the uneven shape, in the axially orthogonal section orthogonal to the rotational axis (X) of the rotor (2) in the attached state in which the permanent magnet (1) is attached to the rotor (2). In the uneven shape, the virtual central line (VC) is repeatedly protruded and recessed with the curvature that is larger than the average curvature of the magnetic pole surfaces (10). Here, the virtual central line (VC) connects the intermediate positions of the separation distance (D) of the two magnetic pole surfaces (10).

Between a straight line and a curved line that connect two same points, the curved line is longer. Here, in the axially orthogonal section, a comparison will be made between the rectangular flat plate-shaped permanent magnet (100), in which the magnetic pole surface (10) is linear, and the curved permanent magnet (1), in which the magnetic pole surface (10) has the recesses and projections (20) and which has the uneven shape. In the axially orthogonal section in the attached state, even if the length (W) between end portions of the permanent magnet (1, 100) in the circumferential direction (C) are the same, the extending length of the magnetic pole surface (10) is longer in the case of the permanent magnet (1) in which the section of the magnetic pole surface (10) is curved, than the rectangular flat plate-shaped permanent magnet (100) in which the section of the magnetic pole surface (10) is linear. More effective magnetic flux is generated if the surface area of the magnetic pole surface (10) is larger. Thus, by making the section of the magnetic pole surface (10) curved, it is possible to increase the effective magnetic flux without increasing the length of the permanent magnet in the circumferential direction and the axial direction of the rotor core. That is, with the present configuration, it is possible to suppress an increase in the size of the rotor as well as increase the effective magnetic flux of the permanent magnet attached to the rotor.

Here, it is preferable that the uneven shape be continuously changed along the rotor (2) in the circumferential direction, in the attached state.

With this configuration, the permanent magnet (1) is able to regularly generate stable magnetic flux (B).

In one aspect, it is preferable that the two magnetic pole surfaces (10) be the first magnetic pole surface (11) and the second magnetic pole surface (12). Also preferably, the recessed portion (22) of the uneven shape of the first magnetic pole surface (11) and the projected portion (21) of the uneven shape of the second magnetic pole surface (12) are formed at corresponding positions along the circumferential direction (C) of the rotor (2) in the attached state. It is also preferable that the projected portion (21) of the uneven shape of the first magnetic pole surface (11) and the recessed portion (22) of the uneven shape of the second magnetic pole surface (12) be formed at corresponding positions along the circumferential direction (C) of the rotor (2) in the attached state.

With this configuration, since the recessed portion (22) and the projected portion (21) correspond to each other between the different magnetic pole surfaces, the thickness of the permanent magnet (1) in the direction orthogonal to the approximate flat plane (RP) of the magnetic pole surface (10) can be substantially uniformized. Thus, it is possible to obtain the permanent magnet (1) that is not easily demagnetized and that stably generates magnetic flux. The approximate flat plane (RP) is a flat plane obtained by approximating the magnetic pole surfaces (10) that are curved in the axially orthogonal section to be linear in the axially orthogonal section.

Suppose the permanent magnet (1) used for the rotor (2) of the rotary electric machine has the uneven shape, in which the virtual central line (VC) is repeatedly projected and recessed with the curvature that is larger than the average curvature of the magnetic pole surfaces (10). Here, the virtual central line (VC) connects the intermediate positions of the separation distance (D) of the two magnetic pole surfaces (10), in the axially orthogonal section orthogonal to the rotational axis (X) of the rotor (2) in the attached state in which the permanent magnet (1) is attached to the rotor (2). In such a case, it is preferable that the separation distance (D) be the same at each position in the direction along the magnetic pole surface (10) in the axially orthogonal section.

With this configuration, the thickness of the permanent magnet (1) can be uniformized. Thus, the permanent magnet (1) is not easily demagnetized, which makes it possible for the permanent magnet (1) to stably generate magnetic flux.

In one aspect, it is preferable that in the permanent magnet (1) in the attached state, the direction of magnetic flux (B) at the magnetic pole surface (10) be the direction orthogonal to the surface of the rotor (2).

With this configuration, in the axially orthogonal section, variation of magnetic flux (B) is reduced in the direction along the approximate straight line (RL) of the magnetic pole surfaces (10). For example, it is possible to form the rotor (2) that has magnetic characteristics of being able to suppress the generation of torque called ripple torque or cogging torque, by disposing the permanent magnet (1) close to the surface of the rotor core (3). The approximate straight line (RL) is a straight line obtained by approximating the magnetic pole surfaces (10) that are curved in the axially orthogonal section to be linear in the axially orthogonal section.

In one aspect, it is preferable that in the permanent magnet (1), the direction of magnetic flux (B) at the magnetic pole surface (10) be the direction orthogonal to the magnetic pole surface (10).

With this configuration, for example, it is possible to uniformize the thickness of the permanent magnet (1) in the direction along magnetic flux (B). Thus, it is possible to suppress occurrence of demagnetization and form a very reliable permanent magnet (1).

It is preferable that the rotor (2) be a rotor for an interior permanent magnet rotary electric machine.

In a rotor for an interior permanent magnet rotary electric machine, the air gap called the flux barrier is often provided between the magnetic poles to suppress short circuiting of magnetic flux (B) between the magnetic poles (P) that are adjacent to each other in the circumferential direction (C) (magnetic flux short circuiting between magnetic poles). Additionally, the path (q axis magnetic flux path) of magnetic flux (so-called q axis magnetic flux in the d-q axis vector coordinate system) for generating reluctance torque is often provided between the magnetic poles (P) that are adjacent to each other in the circumferential direction (C). Thus, there is a limit to the width (W) in which the permanent magnet (1) can be installed in one magnet pole (P) in the direction along the circumferential direction (C). With the magnetic pole surface (10) being a curved surface that has the uneven shape in the axially orthogonal section, it is possible for the magnetic pole surface (10) to have a surface area beyond the limit of the width (W). Thus, it is possible to increase magnetic flux (B) generated according to the surface area of the magnetic pole surface (10). Therefore, in a rotor for an interior permanent magnet rotary electric machine, it is preferable that the permanent magnet (1) with the configuration described above be applied.

1-8. (canceled)

9. A rotary electric machine comprising:
a rotor; and
a permanent magnet, wherein:
in an axially orthogonal section orthogonal to a rotational axis of the rotor in an attached state in which the permanent magnet is attached to the rotor, the permanent magnet has an uneven shape, in which both of two magnetic pole surfaces are repeatedly projected and recessed with a curvature that is larger than an average curvature of magnetic pole surfaces.

10. The rotary electric machine according to claim 9, wherein
the uneven shape is continuously changed along a circumferential direction of the rotor in the attached state.

11. The rotary electric machine according to claim 10, wherein
the two magnetic pole surfaces are a first magnetic pole surface and a second magnetic pole surface,
a recess of the uneven shape of the first magnetic pole surface and a projection of the uneven shape of the second magnetic pole surface are formed at corresponding positions along the circumferential direction of the rotor in the attached state, and
a projection of the uneven shape of the first magnetic pole surface and a recess of the uneven shape of the second magnetic pole surface are formed at corresponding positions along the circumferential direction of the rotor in the attached state.

12. The rotary electric machine according to claim 11, wherein
a direction of magnetic flux at the magnetic pole surface is a direction orthogonal to a surface of the rotor in the attached state.

13. The rotary electric machine according to claim 12, wherein
the rotor is a rotor for an interior magnet rotary electric machine.

14. The rotary electric machine according to claim 9, wherein
the two magnetic pole surfaces are a first magnetic pole surface and a second magnetic pole surface,
a recess of the uneven shape of the first magnetic pole surface and a projection of the uneven shape of the second magnetic pole surface are formed at corresponding positions along the circumferential direction of the rotor in the attached state, and
a projection of the uneven shape of the first magnetic pole surface and a recess of the uneven shape of the second magnetic pole surface are formed at corresponding positions along the circumferential direction of the rotor in the attached state.

15. The rotary electric machine according to claim 9, wherein
a direction of magnetic flux at the magnetic pole surface is a direction orthogonal to a surface of the rotor in the attached state.

16. The rotary electric machine according to claim 9, wherein
a direction of magnetic flux at the magnetic pole surface is a direction orthogonal to the magnetic pole surface.

17. The rotary electric machine according to claim 9, wherein
the rotor is a rotor for an interior magnet rotary electric machine.

18. A rotary electric machine comprising:
a rotor; and
a permanent magnet, wherein:
in an axially orthogonal section orthogonal to a rotational axis of the rotor in an attached state in which the permanent magnet is attached to the rotor, the permanent magnet has an uneven shape, in which a virtual central line is repeatedly projected and recessed with a curvature that is larger than an average curvature of two magnetic pole surfaces, the virtual central line connecting intermediate positions of a separation distance of magnetic pole surfaces.

19. The rotary electric machine according to claim 18, wherein
the separation distance is the same at each position in a direction along the magnetic pole surface in the axially orthogonal section.

20. The rotary electric machine according to claim 19, wherein
a direction of magnetic flux at the magnetic pole surface is a direction orthogonal to a surface of the rotor in the attached state.

21. The rotary electric machine according to claim 20, wherein
the rotor is a rotor for an interior magnet rotary electric machine.

22. The rotary electric machine according to claim 18, wherein
a direction of magnetic flux at the magnetic pole surface is a direction orthogonal to a surface of the rotor in the attached state.

23. The rotary electric machine according to claim 18, wherein
a direction of magnetic flux at the magnetic pole surface is a direction orthogonal to the magnetic pole surface.

24. The rotary electric machine according to claim 18, wherein
the rotor is a rotor for an interior magnet rotary electric machine.
